(19) United States
(12) Patent Application Publication
(10) Pub. No.: US 2006/0187178 A1
(43) Pub. Date: Aug. 24, 2006

(54) Liquid crystal display device

(76) Inventor: Wein-Town Sun, Longtan Township (TW)

Correspondence Address: RABIN & Berdo, PC, 1101 14TH STREET, NW, SUITE 500, WASHINGTON, DC, 20005, US

(21) Appl. No.: 11/410,256

(22) Filed: Apr. 25, 2006

Related U.S. Application Data
(63) Continuation-in-part of application No. 10/627,610, filed on Jul. 28, 2003.

(51) Int. Cl. G09G 3/36

(52) U.S. Cl. 345/100

(57) ABSTRACT

A liquid crystal display device. The liquid crystal display device comprises pulse generation, sampling, comparison, latch, and digital-to-analog conversion capabilities. A sample pulse is generated, which samples in time series a digital signal input corresponding to a pixel. The input digital signal is sampled in response to the sampling pulses and compared to a reference voltage to output a comparison result. The comparison result is held until an analog signal is produced therefore by conversion, based on a digital signal held by the latch and then applied to a corresponding pixel.

### CROSS-REFERENCE TO RELATED APPLICATIONS

This application is a continuation-in-part (CIP) of U.S. patent application Ser. No. 10/627,610, filed on Jul. 28, 2003 and now pending, incorporated by reference for all purposes as if fully set forth herein.

### BACKGROUND OF THE INVENTION

1. Field of the Invention

The invention relates to a liquid crystal display (LCD) device, and more particularly to a liquid crystal display (LCD) device having a driving circuit to decrease the number of I/O pins on a FPC, and the number of signal lines on the LCD panel, thereby decreasing the layout size and power requirements of the LCD and, thereby, development costs.

2. Description of the Related Art

A source driver can receive fast digital data sequentially and convert it into slower parallel digital signals. The source driver can then convert the slower digital signals into analog voltage to drive liquid crystal displays (LCD). A display panel is formed of many pixels. For example, a super video graphics array (SVGA) LCD panel has 800 (horizontal lines)×600 (vertical lines) pixels. In this case, the source driver on the panel requires 800 units of corresponding circuits to properly write all data in the pixels. Each unit has a one-bit shift register, three (R, G, B) n-bit sample latches and hold latches, three digital-to-analog converters (DACs) and three analog buffers. Therefore, such a source driver requires a large area. Thus, reducing required area when designing, for example, the source driver, is very important. Another benefit is increased resolution, particularly for novel source driver-on-panel display systems such as LCOS, LTPS TFT-LCD, OLED and the like.

FIG. 1 is a block diagram illustrating a typical LTPS TFT-LCD. As shown in FIG. 1, the LTPS TFT-LCD disclosed in U.S. Pat. No. 6,256,024 has a structure in which a pixel and a driving circuit for receiving a digital signal having a signal level less than that of a power source voltage (Vdd) of the horizontal driving circuit system are formed in combination on a glass substrate. The LTPS TFT-LCD comprises a horizontal shift register 122, a set of sampling switches 102-1 to 102-n, a set of level shifters 104-1 to 104-n, a set of latches 106-1 to 106-n, a set of digital-to-analog converters (DACs) 108-1 to 108-n, a set of buffers 110-1 to 110-n, a pixel 116, data lines 114-1 to 114-n, scan lines 112-1 to 112-n and a vertical shift register 120.

The scan lines 112-1 to 112-n are vertically scanned successively by the vertical shift register 120 which functions as a vertical scanning circuit and driver.

The horizontal shift register 122, which functions as a horizontal scanning circuit, generates a sampling pulse for sampling an input digital data in time series corresponding to a pixel based on a horizontal start pulse Hst and horizontal clock pulse Hck, and generates a level shift pulse as described hereinafter. The sampling switches 102-1 to 102-n are provided corresponding to n column lines 114-1 to 114-n, and sample digital data on a data bus line in response to the sampling pulse supplied successively from the horizontal shift register 122.

Digital data sampled successively by the sampling switches 102-1 to 102-n is supplied to level shifts which function as the level converter. The level shifts 104-1 to 104-n shift the signal level of respective sampling data to a power source voltage (Vd) level of a horizontal driving circuit system based on a level shift pulse given by the horizontal shift register 122. Respective sampling data shifted by level shifts 104-1 to 104-n are held during one horizontal time period by the latches 106-1 to 106-n.

Respective latch data of latches 106-1 to 106-n are converted to analog signals by the DACs 108-1 to 108-n, and supplied to the buffers 110-1 to 110-n. The buffers 110-1 to 110-n drive the data lines 114-1 to 114-n based on analog signals given by the DACs 108-1 to 108-n.

A digital signal having a signal level less than that of a power source voltage (Vdd) of the horizontal driving circuit system is transmitted until one switch inputs to the corresponding data line, applied to the corresponding pixel. Before inputting the digital signal to the corresponding data line, the level shifter amplifies the digital signal. Thus, the dynamic power consumption depleted during digital signal transmission in data lines is increased. In the apparatus, one level shifter is coupled to a pair of complementary signals. Thus, for an N bit digital signal (N is a natural number), 2N data buses are required. Power depleted during digital signal transmission in 2N data bus exceeds that depleted during digital signal transmission in N data buses. The number of I/O pins on a FPC and the layout size of the LCD are thus increased.

### SUMMARY OF THE INVENTION

It is an object of the present invention to provide a liquid crystal display (LCD) device having a driving circuit to decrease the number of I/O pins on a FPC, and the number of signal lines on the LCD panel, thereby decreasing the layout size and power requirements of the LCD and, thereby, development costs.

The present invention thus provides a liquid crystal display device. The liquid crystal display device has a driving circuit and a plurality of pixel units formed in combination, capable of accepting digital signal input. The liquid crystal display device comprises a shift register, a set of switches, a set of comparators, a set of latches, and a set of digital-to-analog converters. The shift register generates a sample pulse which samples in time series an input digital signal corresponding to one of the pixel units. Each switch samples the corresponding input digital signal in response to the corresponding sampling pulse. Each comparator receives the sampled input digital signal for comparison with a reference voltage, outputs a comparison result, and receives the sample pulse corresponding to the last comparator. Each latch is coupled to one of the comparators and holds the corresponding comparison result. Each digital-to-analog converter is coupled to one of the latches, generates an analog signal based on the comparison result held by the corresponding latch, and then applies the analog signal to the corresponding pixel unit.

Furthermore, for different applications, the liquid crystal display device further comprises an analog buffer. The analog buffer receives the analog signal generated previously and applies it to a corresponding pixel.

### DESCRIPTION OF THE DRAWINGS

The present invention is herein described by way of exemplary embodiments, but not limitations, illustrated in the accompanying drawings in which like references denote similar elements, and in which:

FIG. 1 is a block diagram illustrating a typical LTPS TFT-LCD;

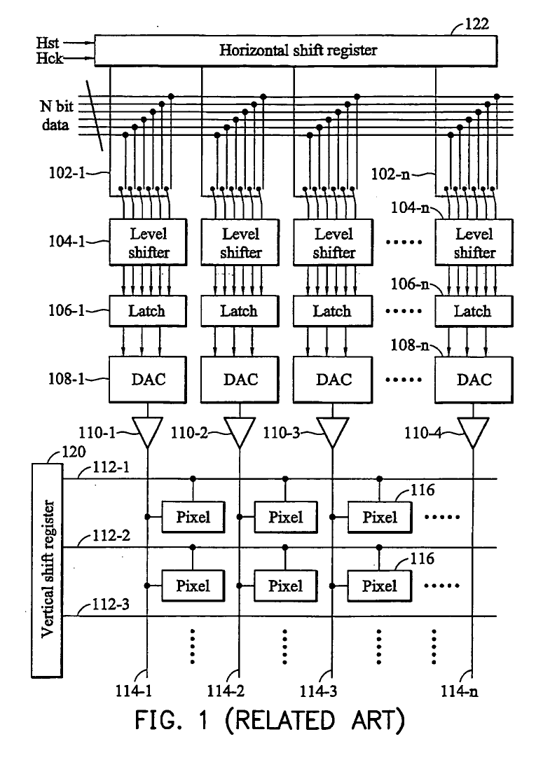

FIG. 2 is a block diagram illustrating a liquid crystal display device according to the embodiment of the invention;

FIG. 3 is a block diagram illustrating an example of the comparator in the embodiment of the invention;

FIG. 4 is a block diagram illustrating an example of the latch and the level shifter in the embodiment of the invention; and

FIG. 5 is a timing diagram illustrating signals in FIG. 2, FIG. 3 and FIG. 4.

### DETAILED DESCRIPTION OF THE INVENTION

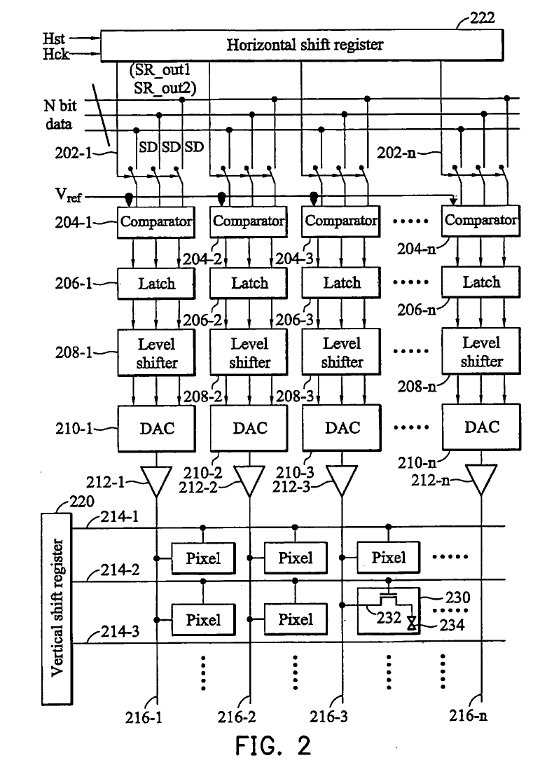

FIG. 2 is a block diagram illustrating a liquid crystal display device according to the embodiment of the invention. An active matrix type liquid crystal display device in accordance with the present invention has a structure in which a pixel and a driving circuit for receiving a digital signal having a signal level lower than that of a power source voltage (Vdd) of the horizontal driving circuit system are formed in combination on a glass substrate. A digital signal to be supplied is a N bit digital data (for color display, the number of total data lines is R, G, B×number of parallel processing).

As shown in FIG. 2, the LCD comprises a horizontal shift register 222, a set of comparators 204-1 to 204-n, a set of latches 206-1 to 206-n, a set of level shifters 208-1 to 208-n, a set of digital-to-analog converters (DACs) 210-1 to 210-n, a set of analog buffers 212-1 to 212-n, a plurality of pixels 230, data lines 216-1 to 216-n, scan lines 214-1 to 214-n and a vertical shift register 220.

The horizontal shift register 222, which functions as a horizontal scanning circuit generates a sampling pulse for sampling an input digital data in time series corresponding to a pixel based on a horizontal start pulse Hst and horizontal clock pulse Hck, and generates a level shift pulse as described hereinafter.

The sampling switches 202-1 to 202-n are provided corresponding to n column lines 216-1 to 216-n, and sample a digital data on a data bus line in response to the sampling pulse supplied successively from the horizontal shift register 222.

Each of the comparators 204-1 to 204-n is coupled to one of sampling switches 202-1 to 202-n. Each of the comparators 201-1 and 204-n receives a digital signal sample by the corresponding sampling switch 202 and a reference voltage V_{ref}. The level of the reference voltage V_{ref} is about half the amplitude of the input digital signal. After comparing the digital signal and the reference voltage V_{ref}, the comparators 201-1 and 204-n output a comparison result. Moreover, a sampling pulse corresponding to one comparator is further provided to the next comparator to reset it, for example, the sampling pulse corresponding to the comparator 204-1 is further provided to the comparator 204-2 to reset it, avoiding the wrong operation of the comparator 204-2.

The comparison result is held during one horizontal time period by the corresponding latches 206-1 to 206-n. The level shifts 208-1 to 208-n amplify the digital signal held by the corresponding latches 206-1 to 206-n to a signal having a high signal level suitable for the DACs 210-1 to 210-n and outputs the signal to the corresponding DACs 210-1 to 210-n.

The DACs 210-1 to 210-n generate an analog signal based on the digital signal transmitted from the corresponding level shifts 208-1 to 208-n. The analog buffers 212-1 to 212-n receive the analog signal generated from the corresponding DACs 210-1 to 210-n and apply the analog signal to a corresponding pixel 230.

On the other hand, the scan lines 214-1 to 214-n are vertically scanned successively by the vertical shift register 220 which functions as a vertical scanning circuit and driver.

In the liquid crystal display device, the pixels 230 are arranged in an array structure. Each pixel 230 includes a liquid crystal 234 and a transistor 232. The drain terminal and the gate terminal of the transistor 232 are connected to the data lines 216-1 to 216-n and the scan lines 214-1 to 214-n, respectively. The source terminal of the transistor 232 is connected to the liquid crystal 234. Furthermore, the data lines 216-1 to 216-n and the scan lines 214-1 to 214-n are coupled to the horizontal shift register 222 and the vertical shift register 220, respectively. These data lines 216-1 to 216-n and scan lines 214-1 to 214-n control the pixels 230 according to image data and scanning control data.

For other liquid crystal display devices, the analog buffers 212-1 to 212-n can be removed.

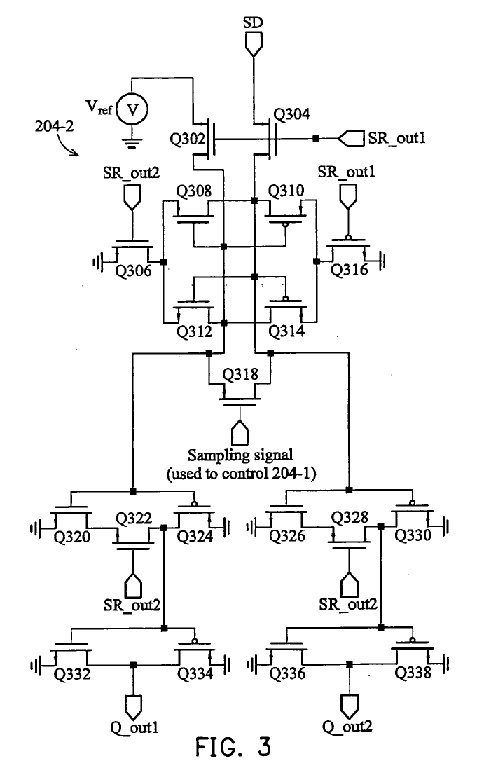

FIG. 3 is a block diagram illustrating an example of the comparator in the embodiment of the invention. A pair of complementary sampling signals instructing the comparators 204-1 to 204-n when to receive a digital signal SD from the corresponding sampling switches 202 are generated from the horizontal shift register 222 shown in FIG. 2. In the embodiment, the amplitude of the digital signal SD is from 0 to 3.3. A pair of complementary sampling signals SR_out1 and SR_out2 to control the comparator 204-2 generated from the horizontal shift register 222 are used as an example to illustrate the embodiment shown in FIG. 3.

As shown in FIG. 3, the comparator 204-2 comprises nineteen transistors Q302, Q304, Q306, Q308, Q310, Q312, Q314, Q316, Q318, Q320, Q322, Q324, Q326, Q328, Q330, Q332, Q334, Q336 and Q338. The source terminal of the transistor Q304 receives the digital signal SD. The source terminal of the transistor Q302 receives the reference voltage V_{ref}. The sampling signal SR_out1 is input to the gate terminals of the transistors Q302, Q304 and Q316. The sampling signal SR_out2 is input to the gate terminals of the transistors Q306, Q322 and Q328. The gate terminal of the transistor Q318 receives one sampling signal which is generated from the horizontal shift register 222 to control the last comparator 204-1. Power is supplied to the source terminals of the transistors Q316, Q324, Q330, Q334 and Q338. The source terminals of the transistors Q306, Q320, Q326, Q332, Q336 and Q338 are coupled to a common electrode (in the embodiment, to ground).

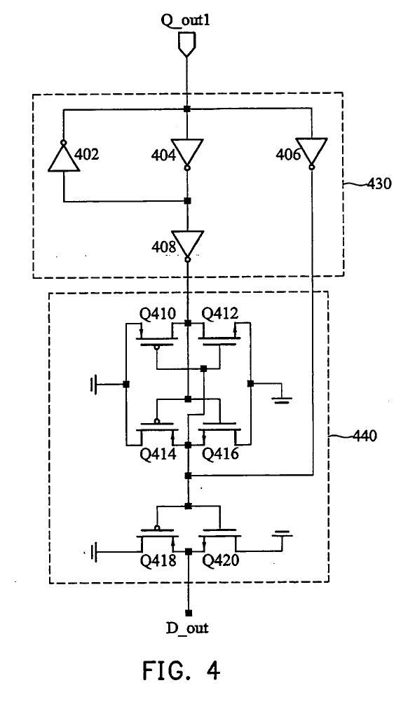

A connected point of the drain terminals of the transistors Q318 and Q334, and the drain terminals of the transistors Q336 and Q338 generate a pair of complementary signals Q_out1 and Q_out2 output respectively. Both of the signals Q_out1 and Q_out2 input to the latch or one of the signals Q_out1 and Q_out2 is selected to input to the latch. Because only one of the signals Q_out1 and Q_out2 is required to input to the latch, signals lines can be decreased. Input of the signal Q_out1 to the latch is used as an example to illustrate the embodiment shown in FIG. 4.

As well as using the circuit shown in FIG. 3 to act as the comparator in the present invention, other circuits which can compare digital signals and reference voltage can be used.

FIG. 4 is a block diagram illustrating an example of the latch and the level shifter in the embodiment of the invention. The latch 430 shown in FIG. 4 is an embodiment of any of latches 206-1 to 206-n. The level shifter 440 shown in FIG. 4 is an embodiment of the level shifter corresponding to the selected latch. For example, the latch 430 shown in FIG. 4 is an embodiment of the latch 206-2. Then, the level shifter 440 shown in FIG. 4 is an embodiment of the level shifter 208-2.

As shown in FIG. 4, the latch 430 comprises four inverters 402, 404, 406 and 408. The level shifter 440 comprises six transistors Q410, Q412, Q414, Q416, Q418 and Q420.

Input terminals of the inverters 404 and 406 are coupled to an output terminal of the comparator and receive the signal Q_out1 (referring to FIG. 3). An output terminal of the inverter 404 is coupled to input terminals of the inverters 402 and 408. An output terminal of the inverter 402 is coupled to the input terminals of the inverters 404 and 406. Output terminals of the inverters 406 and 408 are coupled to the level shifter 440.

The drain terminals of the transistors Q410 and Q412 are coupled to the output terminal of the inverter 408. The drain terminals of the transistors Q418 and Q420 are coupled to the output terminal of the inverter 406. The source terminals of the transistors Q410 and Q412, and the drain terminals of the transistors Q414, Q416, Q418 and Q420 are coupled to a common electrode (in the embodiment, to ground). A connected point of the source terminals of the transistors Q418 and Q420 generates a digital signal D_out output to the digital-to-analog converter.

Besides using the circuit shown in FIG. 4 to perform the latch in the present invention, other circuits which can hold digital data can be used. Furthermore, after the level shifter, for other applications, some buffers or inverters can be added into the liquid crystal display device.

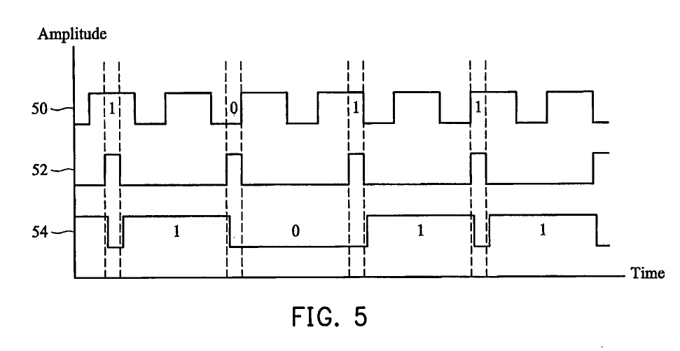

FIG. 5 is a timing diagram illustrating signals in FIG. 2, FIG. 3 and FIG. 4. The vertical axis is amplitude. The horizontal axis is time. Line 50 is the digital signal SD input to the comparator. Line 52 is the sampling signal SR_out1 generated from the horizontal shift register 222. Line 54 is a signal stored in the Latch 430.

When the sampling signal SR_out1 generated from the horizontal shift register 222 first turns on, the digital signal SD (1) is input to the comparator. After comparison with the reference voltage, the digital signal “1” is stored in the latch when the sampling signal SR_out1 generated from the horizontal shift register 222 turns off. When the sampling signal SR_out1 generated from the horizontal shift register 222 subsequently turns on, the digital signal SD (0) is input to the comparator. After being compared with the reference voltage, the digital signal “0” is stored in the latch when the sampling signal SR_out1 then generated from the horizontal shift register 222 turns off. When the sampling signal SR_out1 generated from the horizontal shift register 222 turns on, the digital signal SD (1) is input to the comparator. After comparison with the reference voltage, the digital signal “1” is stored in the latch when the sampling signal SR_out1 generated from the horizontal shift register 222 turns off. When the sampling signal SR_out1 then generated from the horizontal shift register 222 turns on, the digital signal SD (1) is input to the comparator. After comparison with the reference voltage, the digital signal “1” is stored in the latch when the sampling signal SR_out1 generated from the horizontal shift register 222 turns off.

The liquid crystal display device provided by the invention comprises comparators to decrease the number of I/O pins on a FPC and number of signal lines on the LCD panel, thereby decreasing the layout size and power requirements of the LCD and, thereby, development costs.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A liquid crystal display device having a driving circuit and a plurality of pixel units formed in combination, capable of accepting a digital signal input, comprising:
a shift register for generating a sample pulse which samples in time series an input digital signal corresponding to one of the pixel units;
a set of switches, each sampling the corresponding input digital signal in response to the corresponding sampling pulse;
a set of comparators, each receiving the sampled input digital signal for comparison with a reference voltage, outputting a comparison result, and receiving the sample pulse corresponding to the last comparator;
a set of latches, each coupled to one of the comparators and holding the corresponding comparison result; and
a set of digital-to-analog converters, each coupled to one of the latches, generating an analog signal based on the comparison result held by the corresponding latch, and then applying the analog signal to the corresponding pixel unit.

2. The liquid crystal display device of claim 1 further comprising analog buffers, each coupled to one of the digital-to-analog converter, receiving the analog signal generated from the corresponding digital-to-analog converter, and applying the analog signal to the corresponding pixel unit.

3. The liquid crystal display device of claim 1 further comprising level converters, each coupled between one of the latches and one of the digital-to-analog converters, converting the comparison result held by the corresponding latch to a signal having a high signal level, and outputting the signal to the corresponding digital-to-analog converter.

4. The liquid crystal display device of claim 1 wherein the level of the reference voltage is half the amplitude of the input digital signal.

5. The liquid crystal display device of claim 1 wherein each comparator is reset by the sample pulse corresponding to the last comparator.

6. A liquid crystal display device having a driving circuit and a plurality of pixel units formed in combination, capable of accepting a digital signal input, comprising:
a shift register for generating a sample pulse which samples in time series an input digital signal corresponding to one of the pixel units;
a data bus;
a set of switches, each sampling the corresponding input digital signal in the data bus in response to the corresponding sampling pulse, wherein the number of the switches is equal to the number of data lines in the liquid crystal display device;
a set of comparators, each coupled to one of the switches, having a first input terminal for receiving the input digital signal sampled by the corresponding switch and a second input terminal for receiving a reference voltage, and comparing the digital signal and the reference voltage to output a comparison result, wherein each comparator further receives the sample pulse corresponding to the last comparator;
a set of latches, each coupled to one of the comparators, for holding the corresponding comparison result; and
a set of digital-to-analog converters, each coupled to one of the latches for generating an analog signal based on the comparison result held by the corresponding latch and applying the analog signal to the corresponding pixel unit.

7. The liquid crystal display device of claim 6 further comprising a set of analog buffers, each coupled to one of the digital-to-analog converters for receiving the analog signal generated from the corresponding digital-to-analog converter and applying the analog signal to the corresponding pixel unit.

8. The liquid crystal display device of claim 6 further comprising a set of level shifts, each coupled between one of the latches and one of the digital-to-analog converters for amplifying the comparison result held by the corresponding latch to a signal having a high signal level and outputting the signal to the corresponding digital-to-analog converter.

9. The liquid crystal display device of claim 6 wherein the level of the reference voltage is half the amplitude of the input digital signal.

10. The liquid crystal display device of claim 6 wherein each comparator is reset by the sample pulse corresponding to the last comparator.

11. A liquid crystal display device having a driving circuit and a plurality of pixel units formed in combination, capable of accepting a digital signal input, comprising:
a shift register for generating a sample pulse which samples in time series an input digital signal corresponding to one of the pixel units;
a data bus;
a set of switches, each sampling the corresponding input digital signal in the data bus in response to the corresponding sampling pulse, wherein the number of the switches is equal to the number of data lines in the liquid crystal display device;
a set of comparators, each coupled to one of the switches, having a first input terminal for receiving the input digital signal sampled by the corresponding switch and a second input terminal for receiving a reference voltage, and comparing the digital signal and the reference voltage to output a comparison result, wherein each comparator is reset by the sample pulse corresponding to the last comparator;
a set of latches, each coupled to one of the comparators, for holding the corresponding comparison result; and
a set of digital-to-analog converters, each coupled to one of the latches for generating an analog signal based on the comparison result held by the corresponding latch and applying the analog signal to the corresponding pixel unit. 7. The liquid crystal display device of claim 6 further comprising a set of analog buffers, each coupled to one of the digital-to-analog converters for receiving the analog signal generated from the corresponding digital-to-analog converter and applying the analog signal to the corresponding pixel unit.

12. The liquid crystal display device of claim 11 further comprising a set of level shifts, each coupled between one of the latches and one of the digital-to-analog converters for amplifying the comparison result held by the corresponding latch to a signal having a high signal level and outputting the signal to the corresponding digital-to-analog converter.

13. The liquid crystal display device of claim 11 wherein the level of the reference voltage is half the amplitude of the input digital signal.
